(19) United States
(12) Patent Application Publication
(10) Pub. No.: US 2009/0175257 A1
(43) Pub. Date: Jul. 9, 2009

(54) METHOD AND DEVICE FOR DYNAMICALLY CHANGING PREAMBLE DURATION

(75) Inventors: John P. Belmonte, Schaumburg, IL (US); Dipendra M. Chowdhary, Hoffman Estates, IL (US); Kevin M. Ittner, Chicago, IL (US); David G. Wiatrowski, Woodstock, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/969,269

(22) Filed: Jan. 4, 2008

(51) Int. Cl. H04L 29/02

(52) U.S. Cl. 370/345

(57) ABSTRACT

A method and device dynamically changes preamble duration of a message. A message is transmitted over a forward channel to a target device, wherein the message includes a preamble of a predetermined time duration. A reverse channel is monitored for a confirmation message from the target device. The transmission of the preamble is stopped before expiration of the predetermined time duration upon receiving the confirmation message over the reverse channel.

### TECHNICAL FIELD

The technical field relates generally to communication systems and more particularly to wireless communication systems having some scanning devices with reverse channel capabilities.

### BACKGROUND

In conventional wireless communication systems, mobile radios often receive data or control while monitoring multiple wireless resources (also termed herein as channels), which correspond to a set of radio frequencies. Historically this is done by performing a “channel scan,” where the mobile radio switches between each channel of a scan list (also termed herein as a scan member), and monitors for traffic of interest. If no traffic of interest is found on a particular scan member, the radio switches to the next scan member and monitors for traffic of interest, and so on. As the number of scan members increases, the amount of time between each visit to a particular channel increases. Accordingly, when data and control messages are short in duration the scanning radio may miss the messages completely. Moreover, when data or control message are long in duration the scanning radio may miss the beginning, which may make the entire message useless.

This problem has often been mitigated by increasing the size of the data or control message using a special preamble at the beginning of each transmitted data or control message. The length of the preamble is made proportionate to the size of the scanning radio's scan list. If the preamble is as long as it takes the scanning radio to cycle completely through its scan list, the probability of scanning the preamble and therefore receiving the data or control message increases. This assumes that there is no traffic on the other scan members. If there is traffic on the other members, the preamble needs to be even longer to be completely effective. Such an approach drastically impacts bandwidth usage on a channel. In many cases, the preamble utilized is longer than the data or control message itself. This causes a single data or control message to consume more than double the required bandwidth. Of course, this means that the channel can either support fewer users or fewer messages per user when this approach is used.

Further, the transmitting radio does not know the size of its target's scan list, or if its target is even scanning. Because of this, the radio must use the same length preamble for every target, even if it is not required. If the target radio does receive the message during the preamble, it is forced to wait through the entire preamble for the data or control message. The length of the preamble is “one length fits all” and is provisioned via configuration software by the system administrator. As the number of users on a system increases, it becomes increasingly difficult to estimate the average size of a user's scan list, especially when the user has the ability to remove or add scan members himself. This results in preambles that cover the longest scan list any user may have, or possibly result in a much longer preamble than is truly required. The administrator often has to make a virtually blind judgment call on variables that cannot be realistically estimated.

Often, in order mitigate the unknown scanning status of target radios; the first attempt of a confirmed data message does not utilize a preamble. This does help decrease the bandwidth consumed if the majority of the targets are not scanning. If the majority of radios are scanning, the source radio is often forced to retry the original missed message with the preamble in place. In this case, almost tripling the bandwidth the data message itself would use.

Thus, there exists a need for a method and device for optimizing the duration of the preamble of a message exchanged between wireless devices, which address at least some of the shortcomings of past and present techniques of communication between wireless devices.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a communication system of wireless devices, in accordance with some embodiments.

FIG. 2 illustrates a method for dynamically changing preamble duration of a message, in accordance with some embodiments.

FIG. 3 illustrates a method for transmitting a confirmation message via a reverse channel, in accordance with some embodiments.

FIG. 4 illustrates a process of transmission, as existing in prior art.

FIG. 5 illustrates a process of transmission, wherein a target device is non-scanning or has a short scan list, in accordance with some embodiments.

FIG. 6 illustrates a process of transmission, wherein a target device has a medium scan list, in accordance with some embodiments.

FIG. 7 illustrates a process of transmission, wherein a target device is not present, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Device and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a method and device for dynamically changing preamble duration of a message being transmitted over a wireless channel from a source device to a target device in a wireless communication system is shown. The target device scans wireless channels for incoming messages and may be an intended recipient of one or more of the incoming messages. At least one of the incoming messages includes a preamble having a predetermined time duration and a payload, wherein the preamble would result in over-utilization of bandwidth for communication between source and target devices if the entire preamble duration were used with each message transmission.

The method and device utilize reverse channel confirmation messages to dynamically change the duration of the preamble depending on the availability of the target device, thus reducing the bandwidth usage. More particularly, the source device transmits the preamble over a forward channel and monitors a reverse channel. The source device transmits the preamble for the entire predetermined time duration or until it receives a reverse channel message confirming the presence of the target device. If the presence of the target device is confirmed, the source device immediately stops sending the preamble and transmits the payload that may be a data or control message in many instances, but may also include voice. Accordingly, administrators can set a worst case preamble time duration for all radios, but over-utilization of the bandwidth is restricted since the duration of the preamble is optimized.

Moreover, in using the method and device in accordance with the teachings herein, non-scanning radios can confirm immediately causing a significant decrease in preamble duration. The term “immediately” also includes “substantially immediately” since some delay may result based on the equipment being used, and one or more other frames (e.g., a header frame) may precede a given “immediate” action or transmission. Radios with only a few scan members may confirm in a time that is less than the predetermined preamble duration. Radios with larger scan lists may require the entire predetermined preamble duration in some instances, but may not require it in other instances if these radios land early in the preamble due to their scan cycle. Thus, it is expected that on average only half the preamble will be required. Also, if some targets do not have reverse channel capabilities, the source radio can further have a configurable option to transmit the payload even if the target is not confirmed. This allows for backwards compatibility with the radios that are not reverse channel capable. Those skilled in the art will realize that the above recognized advantages and other advantages described herein are merely illustrative and are not meant to be a complete rendering of all of the advantages of the various embodiments.

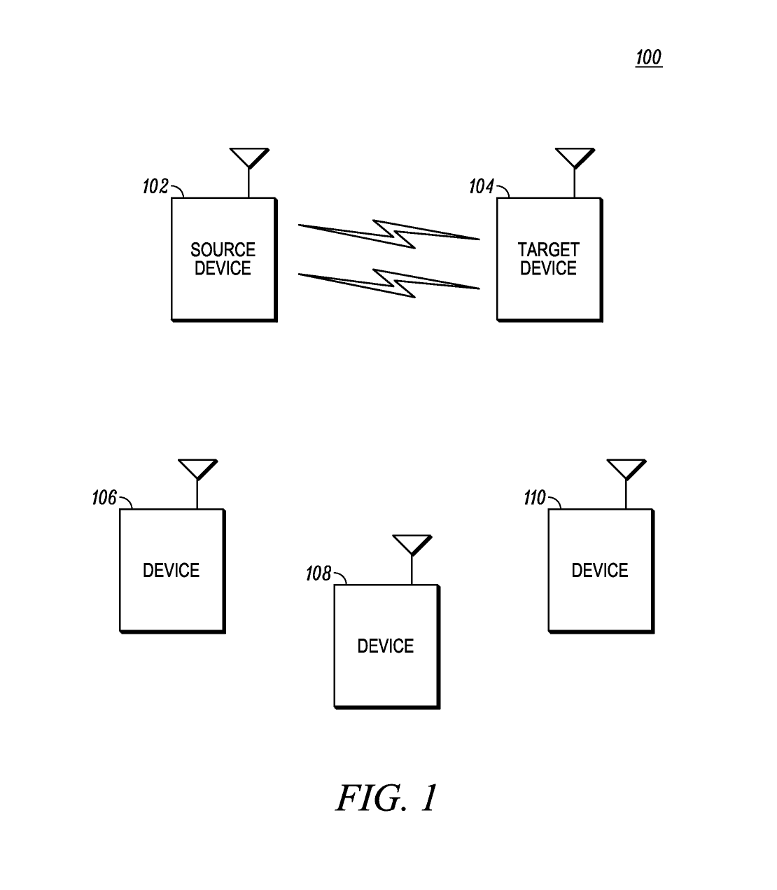

Referring now to the drawings, and in particular FIG. 1, a communication system of devices in accordance with some embodiments is shown and indicated generally at 100. At least some of the devices perform a method for dynamically changing preamble duration in accordance with the teachings herein. The communication system 100 includes a source device 102 sending one or more messages, a target device 104 attempting to detect one or more messages (i.e., traffic) of interest, and devices 106, 108 and 110. It should be readily understood that the devices 106, 108 and 110 can act as source devices or target devices, depending upon the activity being performed by various users of the devices. Similarly, the target device 104 and the source device 102 can interchangeably act as a source device or a target device.

Devices 102, 104, 106, 108 and 110 may be mobile devices (endpoints in the system), and in some system implementations, at least one of these devices may be a base station (an intermediary device in the system). In general, a BS is infrastructure equipment that can receive messages in a wireless signal from one or more mobile devices and transmit the messages in wireless signals to one or more other mobile devices via wireless channels. A BS includes, but is not limited to, equipment commonly referred to as repeaters, base transceiver stations, site controllers, access points, or any other type of interfacing device in a wireless environment. As referred to herein, a mobile device includes, but is not limited to, devices commonly referred to as access terminals, user equipment, mobile stations, mobile subscriber units, or any other device capable of operating in a wireless environment. Examples of mobile devices include, but are not limited to, mobile phones, cellular phones, Personal Digital Assistants (PDAs), laptops and pagers. For purposes of clarity, the system 100 is shown with five devices, but additional or fewer devices may be deployed as understood by those of ordinary skill in the art.

The source device 102 and the target device 104 communicate over a wireless channel to exchange messages between each other. In accordance with implementations described herein, the wireless channels comprise forward channels and reverse channels. In general, a forward channel as used herein is a wireless resource that is used for transmissions initiated by a mobile device and destined for one or more other mobile devices. Thus, the forward channel facilitates transmissions (e.g. voice, data or control) between endpoints in the system 100. A reverse channel as generally used herein is a wireless resource that is a shared resource between a plurality of devices, wherein a device may send messages on the reverse channel while participating in a transmission on the forward channel. In a system implementation that uses base stations, the reverse channel may be used for message between a mobile device and a base station. Thus, in such an embodiment, the reverse channel facilitates transmissions (e.g. a request, a repeated request, and a grant) between an intermediary and an endpoint of the system 100.

One such system, which includes both mobile devices and base stations and that utilizes forward and reverse channels, is a Time Division Multiple Access (TDMA) communication system where each physical channel is divided into logical time slots to carry the communications of the system. For example, in a two-slot TDMA system one time slot is allocated to a forward channel and the other time slot is allocated to a reverse channel. An example of a TDMA system is one that implements the Digital Mobile Radio (DMR) Technical Standard published by the European Telecommunications Standards Institute (ETSI) as Technical Specification (TS) 102 361. However, any proprietary and/or standard air interface techniques may be used. The teachings are also applicable in a Frequency Division Multiple Access (FDMA) system, an Orthogonal Frequency Division Multiplexing (OFDM) system or a Code Division Multiple Access (CDMA) system.

In accordance with an embodiment, the messages contain a payload, which may be, but is not limited to, voice, data or control messages. Further, the payload may be preceded by a preamble. When utilized, the preamble is, thereby, transmitted before the payload and further has a predetermined time duration. The predetermined time duration is the time taken to transmit the complete preamble over the forward channel. The predetermined time duration is set in the source device, and may have been determined by a system administrator and provisioned into the source device.

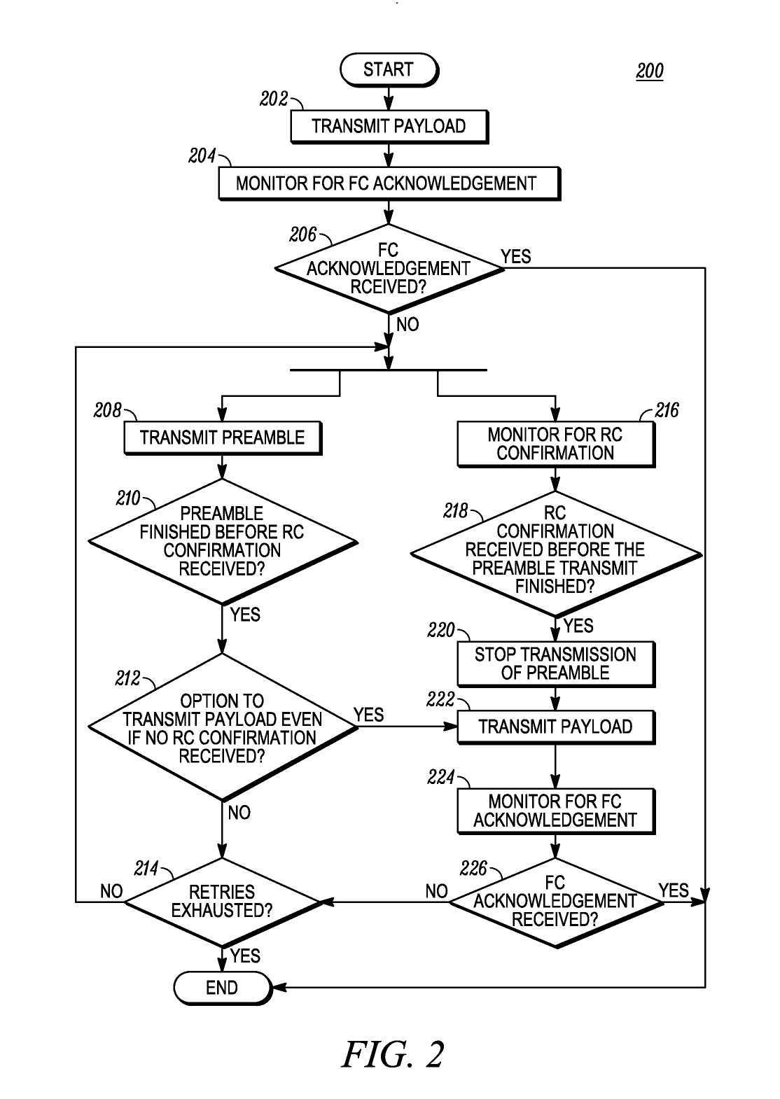

In an embodiment, the devices 102, 104, 106, 108 and 110 are at least equipped with a transceiver (i.e., transmitter and receiver apparatus), a memory and a processing device and are further equipped with any additional components as needed for a commercial embodiment. The transceiver, memory and processing device can have any suitable physical implementation and are topologically coupled depending on the particular device implementation. These components can further be operatively coupled to perform methods in accordance with the teachings herein, for example, as illustratively described by reference to the remaining FIGS. 2 through 7.

Turning now to FIG. 2, a method for dynamically changing preamble duration of a message transmitted by a source device (e.g., 102) to a target device (e.g., 104) is shown and generally indicated at 200. In accordance with an embodiment, the message includes a payload, which is usually, but is not limited to, data or a control message. In another implementation, the message may include other information such as voice, and it should be readily understood by skilled artisans that some type of buffer technique is used if voice is included in the message.

In general, the method includes: transmitting a preamble over a forward channel (FC), with the preamble having a predetermined time duration; monitoring a reverse channel (RC); and stopping the transmission of the preamble before expiration of the predetermined time duration upon receiving a confirmation message from the target device over the reverse channel. However, in accordance with an embodiment, prior to performing these steps, the source device 102 optionally transmits 202 the payload to the target device 104 on the forward channel and monitors 204 the forward channel for an acknowledgement (ACK) from the target device 104. The target device transmits the ACK to the source device after receiving the payload. If the source device receives 206 the ACK within some predetermined time duration, the method 200 ends. If, however, the source device fails to receive 206 the ACK within the predetermined time duration, the message is re-transmitted by including a preamble of predetermined time duration in the message, prior to the payload. In an embodiment, the preamble and the payload comprise a plurality of frames, which are transmitted sequentially when the preamble and the payload are being transmitted. Initially transmitting the message without the preamble may decrease the bandwidth consumed in systems deploying a number of non-scanning devices.

As stated above, the source device optionally performs steps 202 to 206. Thus, in another embodiment, the method begins at steps 208 and 216, wherein the source device 102 starts transmitting 208 the preamble over the forward channel to the target device 104. Further, the source device 102 monitors 216 the reverse channel for a confirmation message from the target device 104. The target device immediately transmits the reverse channel confirmation message after receiving and properly decoding the preamble. If the preamble transmission is completed 210 and no confirmation message was received from the target device 104 before the expiration of the predetermined time duration for the preamble, the source device 102 checks if it has an option 212 to transmit the payload even if it fails to receive the confirmation message over the reverse channel. If the source device 102 does not have the option 212, it checks 214 if a number of re-transmissions of the preamble has exceeded the maximum allowed number of re-transmissions of the preamble to the target device 104. The number of re-transmissions allowed may be anywhere from zero (0) to some predefined integer number of re-transmissions.

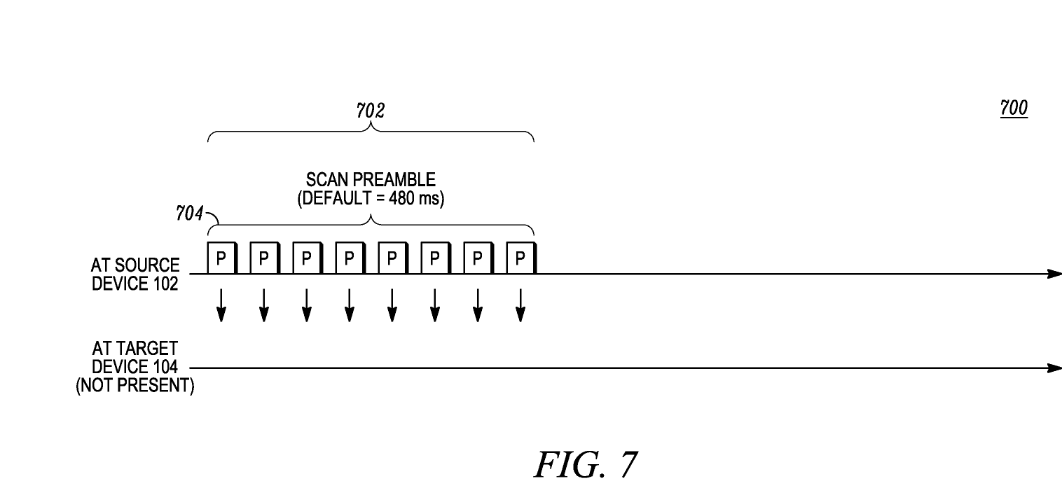

If the number of re-transmissions exceeds the maximum allowed number of re-transmissions of the preamble, the method 200 ends. In one illustrative scenario the target device 104 is not present, causing the source device 102 to stop transmitting after exhausting the maximum allowable number of preamble re-transmissions. This scenario is described in detail later by reference to FIG. 7. Alternatively, if the maximum number of re-transmissions 214 has not been exceeded, the source device 102 restarts the preamble transmission 208 and monitors 216 the reverse channel for a confirmation message by the target device 104.

If the source device 102 has the option 212, the source device 102 transmits 222 the payload to the target device 104, after the expiration of the predetermined time duration of the preamble. The source device 102 then monitors 224 the forward channel for an ACK from the target device 104. If the source device 102 fails to receive 226 the ACK within a predetermined duration of time, the check 214 is performed as described above. However, if the source device 102 receives 226 the ACK, the method 200 ends.

Returning again to the beginning of the right branch of the flow diagram, if the source device 102 receives 218 the confirmation message from the target device 104 over the reverse channel while the preamble is still being transmitted 208, the source device 102 stops the preamble transmission before the expiration of the predetermined time duration of the preamble, as soon as it receives the confirmation message. Once the source device 102 stops transmitting 220 the preamble, the source device transmits 222 the payload to the target device 104. After transmitting the payload, the source device 102 monitors 224 the forward channel for an ACK from the target device 104. If the source device 102 fails to receive 226 the ACK within a predetermined duration of time, the check 214 is performed as described above. However, if the source device 102 receives 226 the ACK, the method 200 ends.

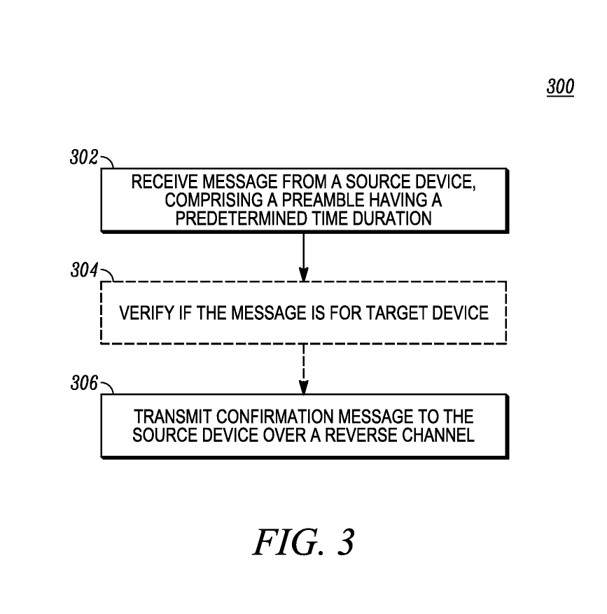

Turning now to FIG. 3, a method for a target device 104 to transmit a confirmation message via a reverse channel to a source device 102 is shown and generally indicated at 300. The target device starts receiving 302 a message from a source device 102, wherein the message includes a preamble having predetermined time duration. The target device 104 optionally verifies 304 if the message is individually addressed to the target device 104. In an embodiment, the preamble includes a 24 bit identification (ID) of the intended target device. The target device 104 transmits 306 the confirmation message to the source device 102 over the reverse channel, immediately after the target device 104 detects the preamble and verifies that the message is for the target device.

Having the option of the target device verifying 304 that the message is individually addressed to the target device is useful in system, for instance, wherein both individually addressed messages are transmitted as well as messages addressed and transmitted to a group of devices. In such systems, the target device can send the reverse channel confirmation messages only in response to the individually addressed messages. However, since group messages are generally received by multiple target devices, possibly each with different scan list size, a fixed preamble can still be used in this scenario in order to reach all the devices in the group. To facilitate a determination of whether the message is individually addressed or is intended for a group, the ID may include an extra bit, which indicates such a distinction. In an alternative embodiment of method 300, the target device 104 does not verify 304 if the preamble is individually addressed to the target device 104, and directly transmits 306 a confirmation message to the source device 102 confirming the receipt of the preamble.

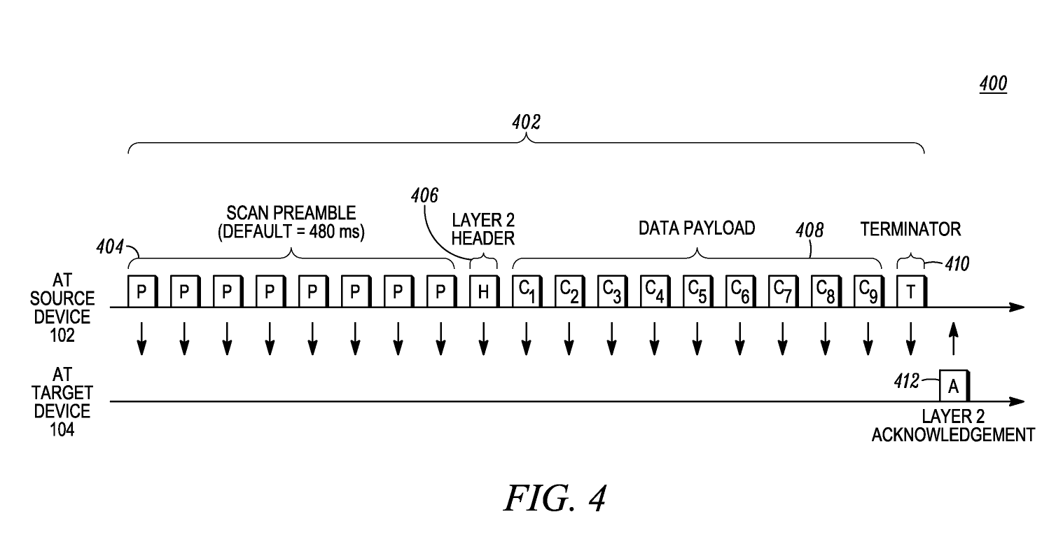

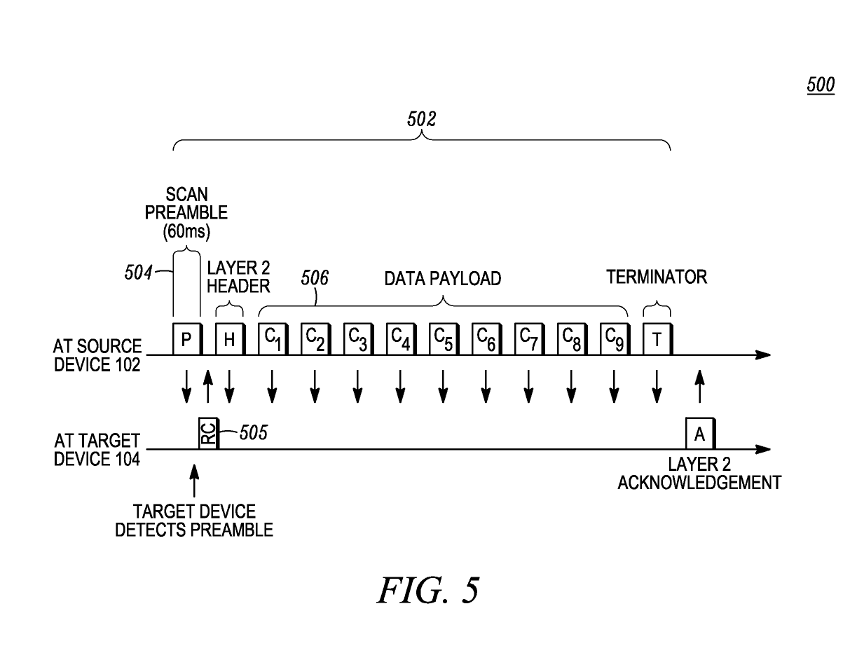

The transmission 306 of the confirmation message is performed immediately, within an acceptable delay, in order to facilitate the confirmation message reaching the source device 102 prior to the completion of preamble transmission. In an embodiment wherein the source device transmits the preamble in frames, the confirmation message is transmitted before receiving a next frame of the preamble. The target device sending the confirmation message and, thereby, causing the source device upon receipt of the confirmation message to stop transmitting the preamble, facilitates dynamically changing the duration of the preamble, in accordance with the teachings herein. For example, as shown in FIG. 5, the confirmation message is sent by the target device 104 as early as 60 ms after transmission of the preamble begins, whereas the complete predetermined duration of the preamble is 480 ms (see, e.g., FIG. 4). This dynamic variation of the preamble duration allows for only the optimal preamble length to be transmitted to a target device 104, thus optimizing the bandwidth usage considerably.

Turning now to FIG. 4, a process of transmission of a message, as existing in prior art, is shown and generally indicated at 400. In accordance with FIG. 4, the source device 102 transmits a message 402 to the target device 104. In this embodiment, the message 402 includes a preamble 404 of 480 ms duration, a header 406 indicating the start of payload, payload 408, and a terminator 410 indicating the end of the payload. The source device 102 transmits the message 402 frame-by-frame, wherein the preamble 404 includes 8 frames of duration 60 ms each. Similarly, the header 406 and the terminator 410 include a frame each of duration 60 ms, and the payload includes 9 frames of duration 60 ms each. If the target device 104 receives and correctly decodes the message 402 it sends an acknowledgement 412 to the source device 102. Generally, the target device 104 can fall into one of the following categories: non-scanning, short-list scanning, medium-list scanning, long-list scanning, or not present. In accordance with FIG. 4, independent of the category into which the target device 104 falls, the complete preamble 404 is transmitted.

This mode of transmission heavily impacts the bandwidth usage in a channel, even in situations where there are either no or very few target devices present. Moreover, FIG. 4 illustrates a preamble having a duration of 480 ms. However, the preamble duration can be much longer, depending on the length of the scan list. For instance, if the network includes devices with up to a 16 member scan list, the preamble duration could be close to three seconds. In general, the method described herein provides better bandwidth utilization and hence overall better performance than a conventional method having a fixed preamble length.

FIGS. 5-7 illustrate various processes of transmission of messages from a source device 102 to a target device 104, pursuant to various embodiments. Turning first to FIG. 5, a process of transmission, wherein the target device 104 is non-scanning or has a short scan list is shown and generally indicated at 500. In accordance with the embodiment shown in FIG. 5, the source device 102 starts transmitting the preamble over the forward channel by sending a preamble frame 504 of a message 502 to the target device 104. Further the source device 102 monitors the reverse channel for a confirmation message from the target device 104. In an embodiment, the source device 102 monitors the reverse channel after every preamble frame transmission. As the target device 104 scans or monitors (in the case of a non-scanning device) the forward channel, the target device receives the preamble frame 504. As soon as the target device 104 receives the preamble frame 504, it sends a confirmation message 505 through the reverse channel to the source device 102. In accordance with this embodiment, the length of the preamble frame is 60 ms. If the target device 104 is scanning or otherwise monitoring the forward channel along which the source device 102 starts preamble transmission, the target device 104 responds with the confirmation message 505 60 ms after the source device 102 starts preamble transmission.

Upon receiving the confirmation message 505, the source device 102 immediately stops the transmission of the preamble 504, and starts transmitting a header and then a payload 506 of the message 502. As shown in FIG. 5, the preamble 504 is transmitted for only 60 ms, which would have otherwise taken 480 ms for transmission (as shown in FIG. 4). Substantially immediately after the transmission of the preamble 504 is stopped, the payload 506 is transmitted, since a header precedes the payload in this example. Thus, as described in this embodiment, non-scanning target devices, or target devices with short scan lists can confirm substantially immediately on receipt of a preamble, thus causing a considerable decrease in the preamble length being transmitted.

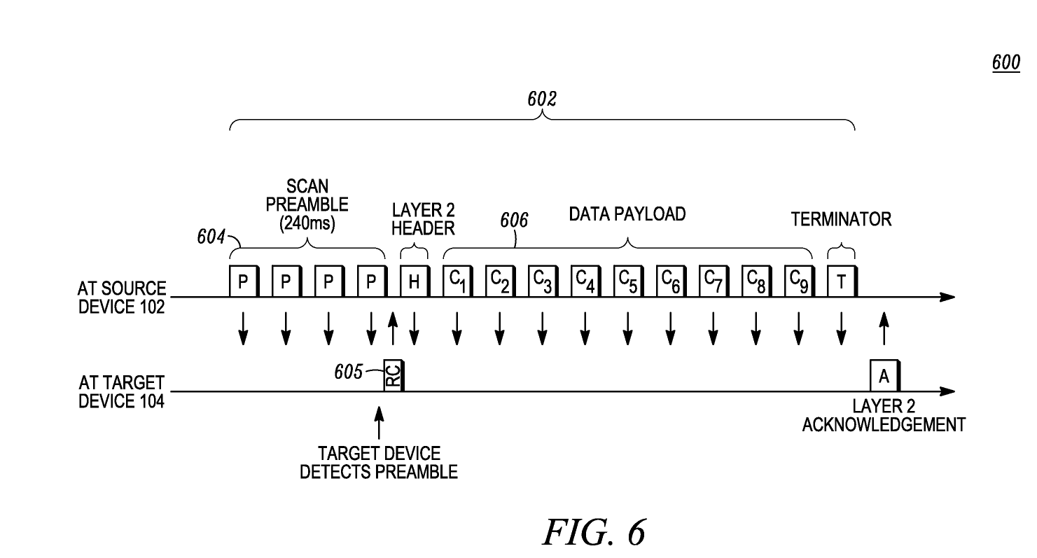

Turning now to FIG. 6, a process of transmission, wherein the target device 104 has a medium scan list is shown and generally indicated at 600. In accordance with the embodiment shown in FIG. 6, a preamble 604 of a message 602 is transmitted for 240 ms during which 4 frames of the preamble are transmitted. The preamble 604, which would have taken 480 ms for transmission (as shown in FIG. 4), is transmitted for 240 ms due to the medium scan list of the target device 104. Immediately after the transmission of the preamble 604 is stopped by a reverse channel confirmation message 605, a header and then a payload 606 is transmitted. As shown in this embodiment, target devices with medium scan lists may generally transmit the confirmation message in around half the time of the preamble duration. Target devices with larger scan lists may receive the entire preamble having a duration of 480 ms. However, this may not always be the case, if the target devices with long scan lists land early in the preamble transmission due to their scan cycle. Therefore, it is expected, that on an average, only half the preamble will be transmitted from the source device 102 to the target device 104.

Turning now to FIG. 7, a process of transmission, wherein the target device 104 is not present is shown and generally indicated at 700. In accordance with the embodiment shown in FIG. 7, the source device 102 sends a preamble 704 of a message 702 to the target device 104. However, due to the absence of the target device 104, no reverse channel confirmation message is received by the source device 102. Therefore, after completing the transmission of the preamble 704, the source device 102 does not transmit a payload (not shown in FIG. 7). As shown in FIG. 7, the complete preamble 704 of duration 480 ms is transmitted, and then the transmission of the message 702 is stopped. In an alternative embodiment, the administrator of the wireless communication system can optionally program the source device 102 to transmit the payload even if a reverse channel confirmation message has not been received by the source device 102. This embodiment may be useful, if the plurality of wireless devices includes target devices that do not have the capability of sending reverse channel confirmations, and can only receive messages over a wireless forward channel. In yet another alternative embodiment, the source device 102 may re-transmit the preamble 704 for a maximum allowed number of re-transmissions, or until a reverse channel confirmation message is received from the target device 104. The maximum allowed number of re-transmissions may be preset by the administrator.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for dynamically changing preamble duration described herein. The non-processor circuits may include, but are not limited to, a radio receiver, a radio transmitter, power source circuits, and user input devices. As such, these functions may be interpreted as steps of a method to perform the dynamically changing of preamble duration described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for dynamically changing preamble duration of a message, wherein the preamble having a predetermined time duration, the method comprising:
transmitting the preamble over a forward channel;
monitoring a reverse channel; and
stopping the transmission of the preamble before expiration of the predetermined time duration upon receiving a confirmation message from the target device over the reverse channel.

2. The method of claim 1, wherein the message further comprising a payload, and the method further comprising transmitting the payload over the forward channel to the target device immediately after stopping the preamble transmission.

3. The method of claim 1, wherein the message further comprising a payload, and the method further comprising, if no confirmation message is received from the target device over the reverse channel while transmitting the preamble, after expiration of the predetermined time duration performing one of:
transmitting the payload over the forward channel to the target device after transmitting the preamble;
re-transmitting the preamble over the forward channel and monitoring the reverse channel for the confirmation message; or
stopping the message transmission.

4. The method of claim 3, wherein the preamble is re-transmitted until one of:
the confirmation message is received from the target device, wherein the payload is transmitted; or
the preamble is re-transmitted a maximum predetermined number of times.

5. The method of claim 1 further comprising:
transmitting a payload to the target device;
monitoring for an acknowledgement from the target device indicating receipt of the payload; and
upon a failure to receive the acknowledgement, transmitting the preamble over the forward channel and monitoring the reverse channel for the confirmation message.

6. The method of claim 1 further comprising setting the predetermined time duration at a source device.

7. The method of claim 1, wherein the message further comprises a payload that is one of voice, data or control.

8. A method for dynamically changing preamble duration of a message, the method comprising:
receiving a message from a source device over a forward channel, the message comprising a preamble having a predetermined time duration; and
transmitting a confirmation message over a reverse channel to the source device to cause the source device to stop transmitting the preamble before expiration of the predetermined time duration

9. The method of claim 8, wherein a target device receives the message from the source device, and the method further comprising verifying that the message is individually addressed to the target device before transmitting the confirmation message.

10. A device comprising:
a transceiver, memory and processing device operatively coupled to perform:
transmitting a preamble over a forward channel, wherein the preamble has a predetermined time duration;
monitoring a reverse channel; and
stopping the transmission of the preamble before expiration of the predetermined time duration upon receiving a confirmation message from the target device over the reverse channel.
